(19) United States
(12) Patent Application Publication
(10) Pub. No.: US 2020/0024116 A1
(43) Pub. Date: Jan. 23, 2020

(54) Bottle Cap Opener And Launcher

(71) Applicant: David L. Gray, Midland, TX (US)

(72) Inventor: David L. Gray, Midland, TX (US)

(21) Appl. No.: 16/574,798

(22) Filed: Sep. 18, 2019

Related U.S. Application Data
(63) Continuation-in-part of application No. 16/511,877, filed on Jul. 15, 2019.
(60) Provisional application No. 62/699,127, filed on Jul. 17, 2018.

(51) Int. Cl. B67B 7/16

(52) U.S. Cl. CPC B67B 7/16; A63H 33/18

(57) ABSTRACT

A bottle cap launcher for launching bottle caps for entertainment. The bottle cap launcher generally includes a body, a collar, and a pry tooth with a shaft mounted in the collar. The launcher also has a spring compressed between the collar and the body, the spring surrounding the pry tooth shaft. The body can slide on the shaft of the pry tooth. Bottle caps can be leveraged under the pry tooth and positioned to compress the spring and displace the body toward the collar. When released, the bottle cap is launched by the body when the spring forces it back to its original, relaxed position on the pry tooth shaft.

### CROSS REFERENCE TO RELATED APPLICATIONS

The present application is a continuation-in-part of U.S. application Ser. No. 16/511,877 filed on Jul. 15, 2019, which claims priority to U.S. Provisional Application No. 62/699,127 filed Jul. 17, 2018. Each of the aforementioned patent applications, and any applications related thereto, is herein incorporated by reference in their entirety.

### STATEMENT REGARDING FEDERALLY SPONSORED RESEARCH OR DEVELOPMENT

Not applicable to this application.

### BACKGROUND

### Field

Example embodiments in general relate to a bottle cap opener and launcher for opening bottles and thereafter launching the removed bottle caps.

### Related Art

Any discussion of the related art throughout the specification should in no way be considered as an admission that such related art is widely known or forms part of common general knowledge in the field.

Bottle openers have been in use for many years as convenient tools for opening bottles, and even as decorative items. However, many bottle openers are not very portable, and some are even permanently or semi-permanently mounted near where bottles are stored or drinks are served.

In addition, some very portable bottle openers are available, but often have protrusions or shapes that make them likely to be hooked on or entangled with other objects when carried in a person's pocket or purse. In addition, previous bottle openers have made no provision for being used for entertainment, such as by launching bottle caps, or by their appearance.

### SUMMARY

An example embodiment is directed to a bottle cap opener and launcher. The bottle cap opener and launcher includes a pry tooth having a shaft, a pry end, and a second end, and a body having a first surface and a collar cavity within the body, the collar cavity having an inner surface defined by a shelf between the collar cavity and the first surface, wherein the pry tooth shaft extends into the collar cavity through an opening in the shelf.

The embodiment also includes a collar movably positioned in the collar cavity, the collar having a coupling end coupled to the pry tooth shaft at the second end, and a compression spring within the collar cavity, positioned over the shaft between the shelf and the coupling end of the collar, wherein the pry tooth and the collar are movable between a retracted position and an extended position.

In some example embodiments, the opening and the collar cavity are cylindrical, and may further be coaxial to each other. In still another example embodiment, the body further comprises a pry tooth recess in the first surface, and an inner surface of the pry tooth recess defines a surface of the shelf. In addition, in embodiments having a pry tooth recess, the recess may also be cylindrical and may further be coaxial with the collar cavity. An inner surface of the pry end may contact the first surface when the pry tooth is in the retracted position, or it may contact an inner surface of the pry tooth recess.

The opener is adapted to remove crown bottle caps and launch them for entertainment. The opener can launch or fling bottle caps to provide a novel, interesting, and fun mechanism that may be used in a game or for personal entertainment. The opener also features improved portability and ease of storage. The opener includes a pry tooth that can be extended for use, and then retracted for improved aesthetics and compactness. The pry tooth can automatically retract once the bottle is opened.

In still another example embodiment, the device may comprise a launcher-only version that is more compact, but may still be used to launch bottle caps as with the previous embodiments, wherein the collar is longer, narrower, and is held directly in a user's hand. This embodiment may have a pry tooth having a shaft, a pry end, and a second end, a body having a first surface and a shaft opening. The pry tooth shaft may extend through the shaft opening and the body may be slidable on the pry tooth shaft. Example embodiments may also include a collar having a coupling end coupled to the pry tooth shaft at the second end, and a compression spring positioned between the collar and the body, such that the compression spring urges the body toward the pry end. In this embodiment, the body is movable between a relaxed position and a compressed position on the pry tooth shaft, since the collar and the pry tooth are held stationary by the user, the compressed position referring to the condition of the spring.

In example embodiments of the launcher version, the body may also comprise a raised flange extending from the first surface, such as a circular flange. In addition, the shaft opening may have a circular cross section, and an inner surface of the pry end can contact the first surface when the body is in the relaxed position.

The pry tooth shaft may in some embodiments be cylindrical, and further, the shaft opening may have a circular cross section. In addition, the pry tooth shaft may be cylindrical and coaxial with the collar. The collar may have different shapes, and may be cylindrical, square, hexagonal, etc.

There has thus been outlined, rather broadly, some of the embodiments of the bottle cap opener and launcher in order that the detailed description thereof may be better understood, and in order that the present contribution to the art may be better appreciated. There are additional embodiments of the bottle cap opener and launcher that will be described hereinafter and that will form the subject matter of the claims appended hereto. In this respect, before explaining at least one embodiment of the bottle cap opener and launcher in detail, it is to be understood that the bottle cap opener and launcher is not limited in its application to the details of construction or to the arrangements of the components set forth in the following description or illustrated in the drawings. The bottle cap opener/launcher is capable of other embodiments and of being used, made, and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a bottle cap opener and launcher in accordance with an example embodiment.

FIG. 2 is another perspective view of a bottle cap opener and launcher in use in accordance with an example embodiment.

FIG. 3 is a side view of a bottle cap opener and launcher in use in accordance with an example embodiment.

FIG. 4 is another side view of a bottle cap opener and launcher in use in accordance with an example embodiment.

FIG. 5 is a sectional, perspective view of a bottle cap opener and launcher in use in accordance with an example embodiment.

FIG. 6 is a sectional view of a bottle cap opener and launcher in accordance with an example embodiment.

FIG. 7 is a sectional view of a bottle cap opener and launcher in use in accordance with an example embodiment.

FIG. 8 is an exploded, sectional view of a bottle cap opener and launcher in accordance with an example embodiment.

FIG. 9 is a side view of a bottle cap opener and launcher in accordance with an alternate example embodiment.

FIG. 10 is a sectional view of a bottle cap opener and launcher in accordance with an alternate example embodiment.

FIG. 11 is a perspective, sectional view of a bottle cap opener and launcher in use in accordance with an alternate example embodiment.

FIG. 12 is a perspective view of a bottle cap opener and launcher in accordance with an alternate example embodiment.

FIG. 13 is another perspective view of a bottle cap opener and launcher in accordance with an alternate example embodiment.

FIG. 14 is another perspective view of a bottle cap opener and launcher in use in accordance with an alternate example embodiment.

FIG. 15 is a perspective view of a bottle cap opener and launcher in accordance with an alternate example embodiment.

FIG. 16 is another perspective view of a bottle cap opener and launcher in accordance with an alternate example embodiment.

FIG. 17 is another perspective view of a bottle cap opener and launcher in accordance with an alternate example embodiment.

FIG. 18 is another perspective view of a bottle cap opener and launcher in accordance with an alternate example embodiment.

FIG. 19 is a perspective view of a bottle cap opener and launcher in use in accordance with an alternate example embodiment.

FIG. 20 is a side view of a bottle cap opener and launcher in use in accordance with an alternate example embodiment.

FIG. 21 is a sectional view of a bottle cap opener and launcher in accordance with an alternate example embodiment.

FIG. 22A is a sectional view of a bottle cap opener and launcher in accordance with an alternate example embodiment.

FIG. 22B is a sectional view of a bottle cap opener and launcher in accordance with an alternate example embodiment.

FIG. 23A is a sectional view of a bottle cap opener and launcher in accordance with an alternate example embodiment.

FIG. 23B is another sectional view of a bottle cap opener and launcher in accordance with an alternate example embodiment.

FIG. 24A is a perspective view of a bottle cap launcher in accordance with an alternate example embodiment.

FIG. 24B is another perspective view of a bottle cap launcher in accordance with an alternate example embodiment.

FIG. 25A is a perspective view of a bottle cap launcher in use accordance with an alternate example embodiment.

FIG. 25B is another perspective view of a bottle cap launcher in use in accordance with an alternate example embodiment.

FIG. 26A is a partial sectional view of a bottle cap launcher in accordance with an alternate example embodiment.

FIG. 26B is another partial sectional view of a bottle cap launcher in accordance with an alternate example embodiment.

FIG. 26C is another partial sectional view of a bottle cap launcher in accordance with an alternate example embodiment.

FIG. 26D is another partial sectional view of a bottle cap launcher in accordance with an alternate example embodiment.

FIG. 27 is a perspective view of a bottle cap launcher in use accordance with an alternate example embodiment.

FIG. 28 is another perspective view of a bottle cap launcher in use in accordance with an alternate example embodiment.

### DETAILED DESCRIPTION

A. Overview.

An example bottle cap opener and launcher generally comprises a body 12 that holds a collar 20 and a pry tooth 30, wherein the collar can be pressed to cause the pry tooth to extend outwardly from the body. The pry tooth 30, in the extended position, can be used to pry caps off of bottles. The body 12 also serves as a lever to allow the user to operate the opener. The body may have a collar cavity 15, which may be a generally cylindrical opening. The collar 20 can be pushed like a pushbutton to extend the pry tooth 30 for use. The cavity 15 may also have an inner surface 19, with a shaft opening 11 which leads to a pry tooth recess 17.

The opening 11, along with collar cavity 15 and pry tooth recess 17, form a shelf 16 between the collar cavity 15 and the pry tooth recess 17. The shelf may also comprise an inner surface 25 that faces into the pry tooth recess, and against which the inner surface 34 of the pry end rests when the pry tooth 30 is retracted.

To use the opener, a user first extends the pry tooth 30 from the body 12 by depressing the push button face 22, which in turn compresses the compression spring 40. The pry end 33 of the pry tooth 30 is then exposed and available to be positioned under a bottle cap, at which point the bottle cap 50 can be pried off. For entertainment or to play a target game, a user may hold the freed bottle cap 50 with the ends of the fingers and maintain the location of the bottle cap 50 after it is removed, beneath the extended pry tooth 30 with the top of the bottle cap still against the leverage face 13 of the body 12. The user can then quickly let go of the bottle cap 50, and the return of the compression spring 40 to its original position will forcibly retract the pry tooth 30 while at the same time flinging the bottle cap 50 away from the user. Alternatively, a user may load a loose bottle cap 50 into the pry tooth by depressing the push button face 22 to extend the pry tooth 30 and may use the loose bottle cap to pry the pry tooth 30 out to its fullest extent. The bottle cap 50 may then be released, again launching it as described above.

The opening 11, along with collar cavity 15 and pry tooth recess 17, form a shelf 16 between the collar cavity 15 and the pry tooth recess 17. The shelf may also comprise an inner surface 25 that faces into the pry tooth recess, and against which the inner surface 34 of the pry end rests when the pry tooth 30 is retracted.

In an alternative embodiment, the device can be configured in a smaller version that is a launcher only. In such an embodiment, the launcher 10 generally comprises a body 12 that holds a pry tooth 30, with the compression spring 40 surrounding the pry tooth 30 between the body 12 and the collar 20, which acts as a handle in this embodiment.

B. Body.

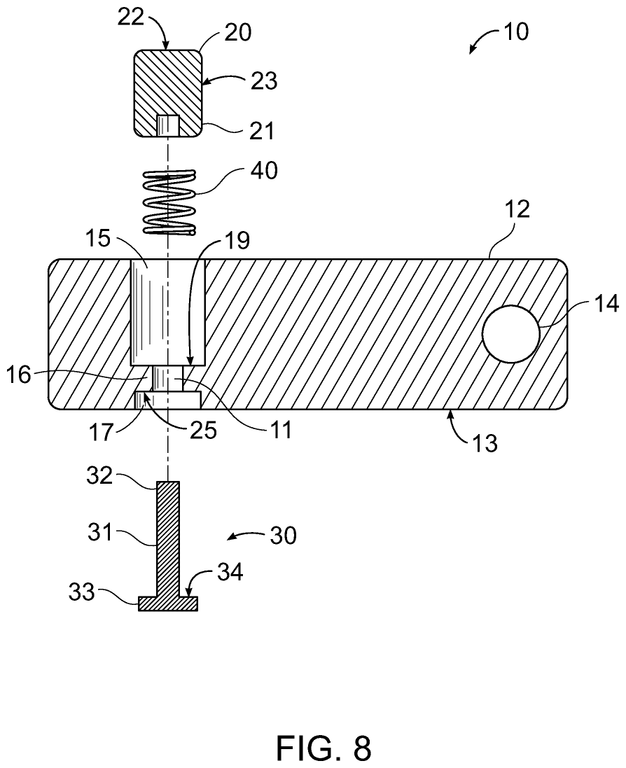

As best shown in FIG. 8, the opener and launcher 10 comprises a body 12 that provides a stable mounting for the other main elements of the example embodiments. The body 12 also provides a coupling zone for coupling between the pry tooth 30 and bottle cap 50. The body 12 also serves as a lever to allow the user to operate the opener/launcher. The construction of the body 12 is generally of sturdy material to enable it to pry off a bottle cap from a bottle. The body 12 provides a base to which the other elements are attached or positioned. Prototypes of opener and launcher 10 have been made of very strong hardwoods such as Purpleheart, Bubinga, and Bloodwood. Other materials may be used, including hard plastics, fiberglass, carbon fiber, and metals.

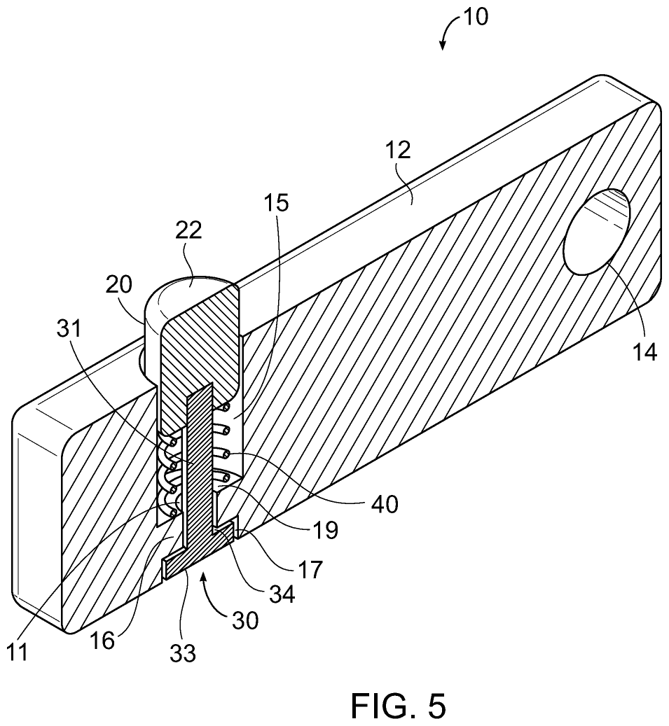

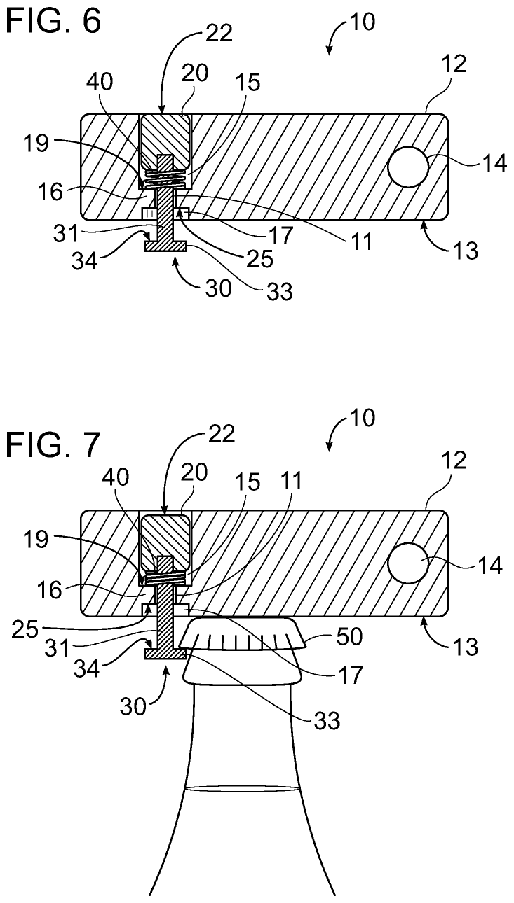

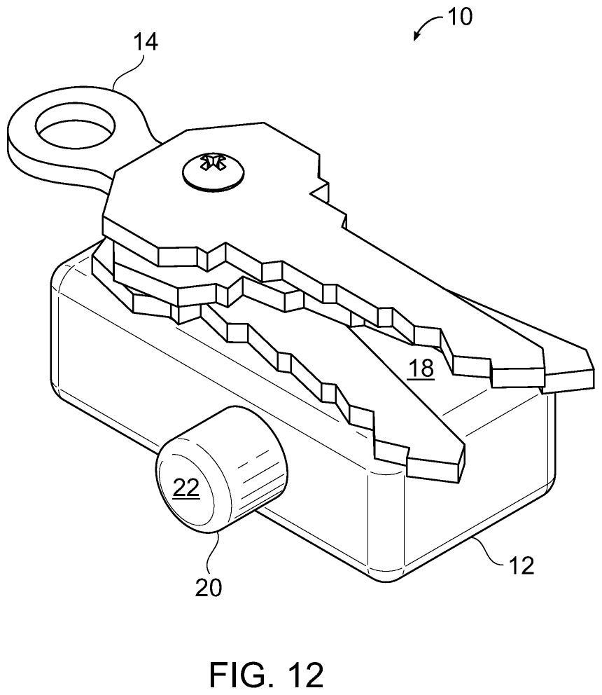

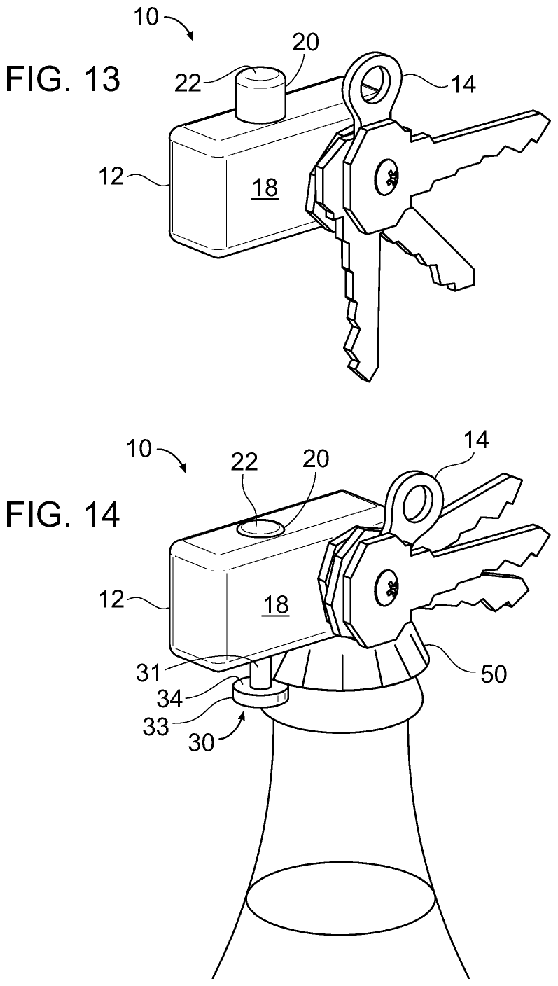

The body 12 must be of sufficient strength to withstand the forces needed to repeatedly pry off bottle caps. The body 12 and its sub-elements may be best understood with reference to FIGS. 5 and 6. The body 12 may function in a variety of shapes and sizes, although a simple, functional rectangular shape is illustrated. The body 12 may have an attachment 14 that may be in the form of a through hole for attachment to a key ring, for example, or it may be in the form of a flat extension with a key ring hole as shown in FIGS. 12-14.

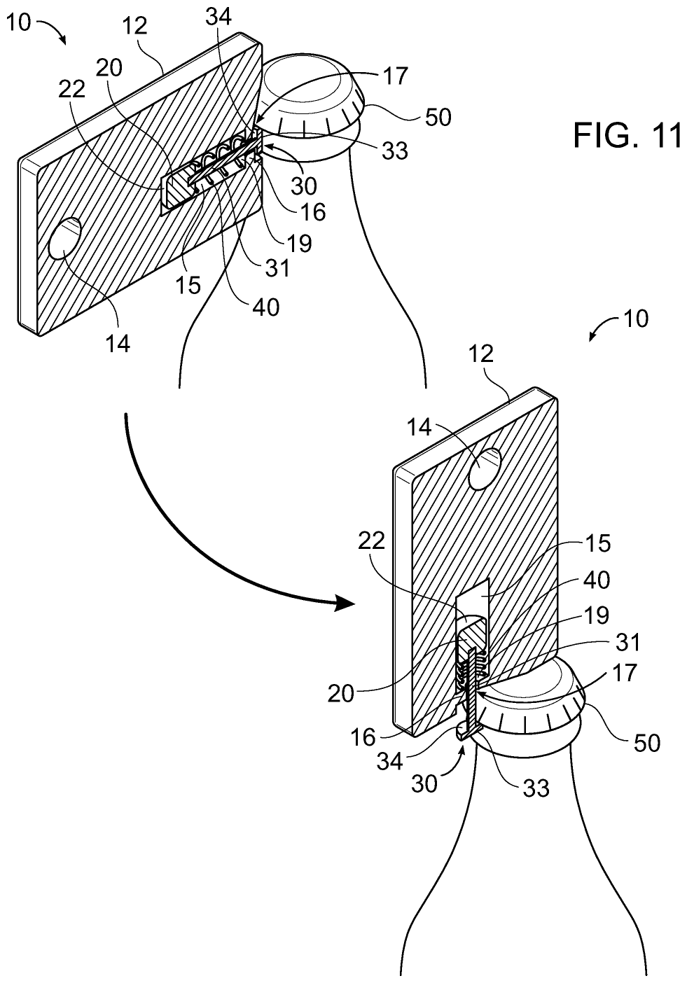

The body may have a collar cavity 15, which may be a generally cylindrical opening. The body 12 may have a collar cavity 15 into which the collar 20 can be pushed to extend the pry tooth 30 for use, as shown for example in FIGS. 7 and 11. The cavity 15 may also have an inner surface 19, with a shaft opening 11 which leads to a pry tooth recess 17. The opening 11, along with collar cavity 15 and pry tooth recess 17, form a shelf 16 between the collar cavity 15 and the pry tooth recess 17. The shelf may also comprise an inner surface 25 that faces into the pry tooth recess, and against which the inner surface 34 of the pry end rests when the pry tooth 30 is retracted.

The shelf 16 serves to provide an inner cavity surface 19 on the collar side. This inner cavity surface 19 provides a face to hold a compression spring 40 in place within the collar cavity 15. The shelf 16 acts to prevent the compression spring 40 and collar 20 from being pulled out of the body 12 when the pry tooth 30 is being used to pry off a bottle cap. The shelf 16 also serves to maintain compression on the compression spring 40 when the bottle cap opener 10 is not being used.

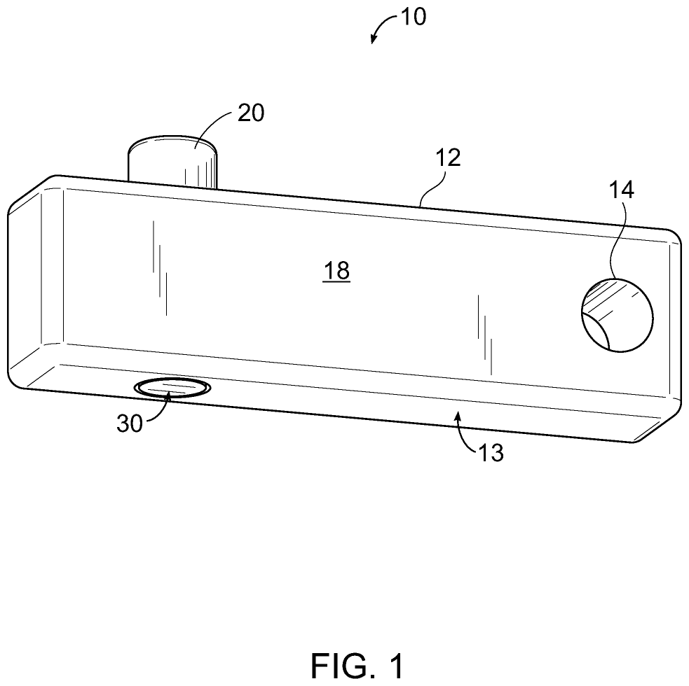

The force of the compression spring 40 retracts and holds the pry tooth 30 in position in the pry tooth recess 17 as shown, for example, in FIG. 1, when the opener is not in use. The shape, depth, and size of the collar cavity 15 may vary depending on the collar 20 used in any particular embodiment. The shelf 16 thickness, as well as the size of the shaft opening 11 through the shelf 16, may vary depending on the length and diameter of the pry tooth shaft 31 and length of compression spring 40, in order to control the distance by which the pry tooth extends out of the body 12.

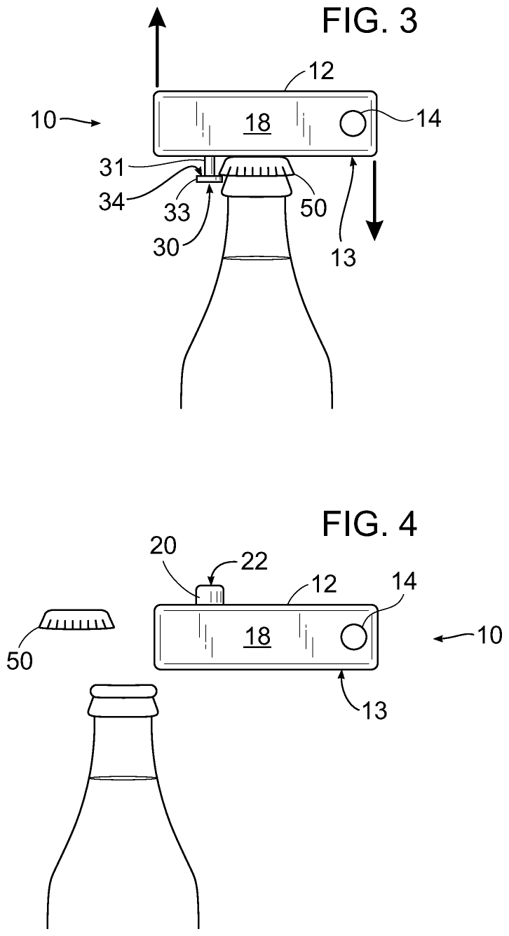

The first surface 13, or leverage face 13 of the body 12 will generally be placed in contact with the top face of a bottle cap 50 during use, as shown in FIGS. 3, 7, 11, 19, and 20. As shown in FIGS. 1, 15, and 19, the pry end 33 of pry tooth 30 may fit within pry tooth recess 17 when the pry tooth is retracted, such that the pry end's outer surface is flush with the leverage face 13. The body 12 can have designs engraved, printed, etc. on any external face, including the leverage face 13. For example, the opener and launcher 10 may have a design face 18, which may include any desired design, logo, decoration, etc.

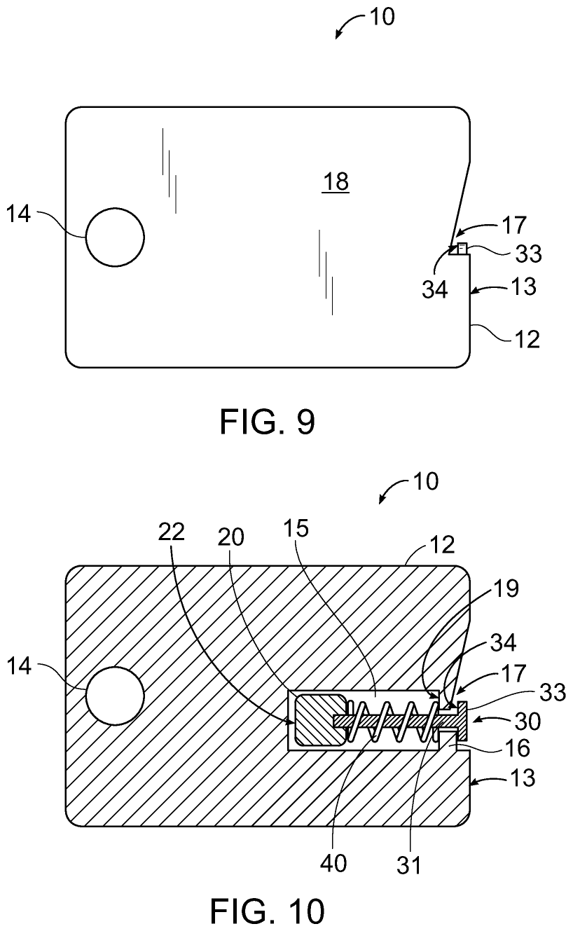

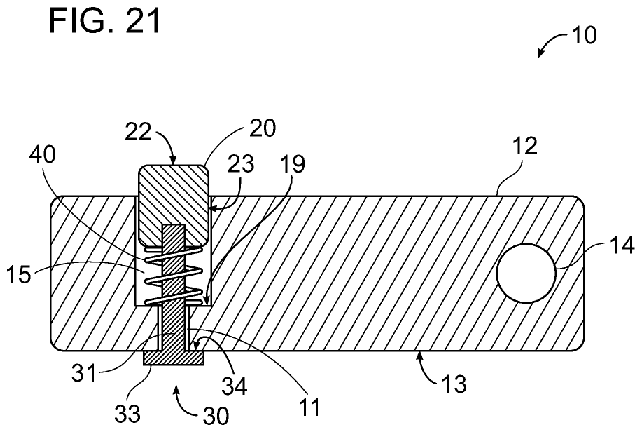

The body 12 can have a variety of structural variations which are generally tied to functional variations. The leverage face 13 can be of different lengths in any number of embodiments in order to help with leverage. The first alternative embodiment is shown in FIG. 9, wherein body 12 has a pry tooth recess 17 that allows a user to use the bottle cap 50 to pull the pry end 33 out of the bottle opener/launcher 10. The pry tooth recess 17 may be absent as seen in FIG. 21, in which case the pry tooth will not be flush with the leverage face 13.

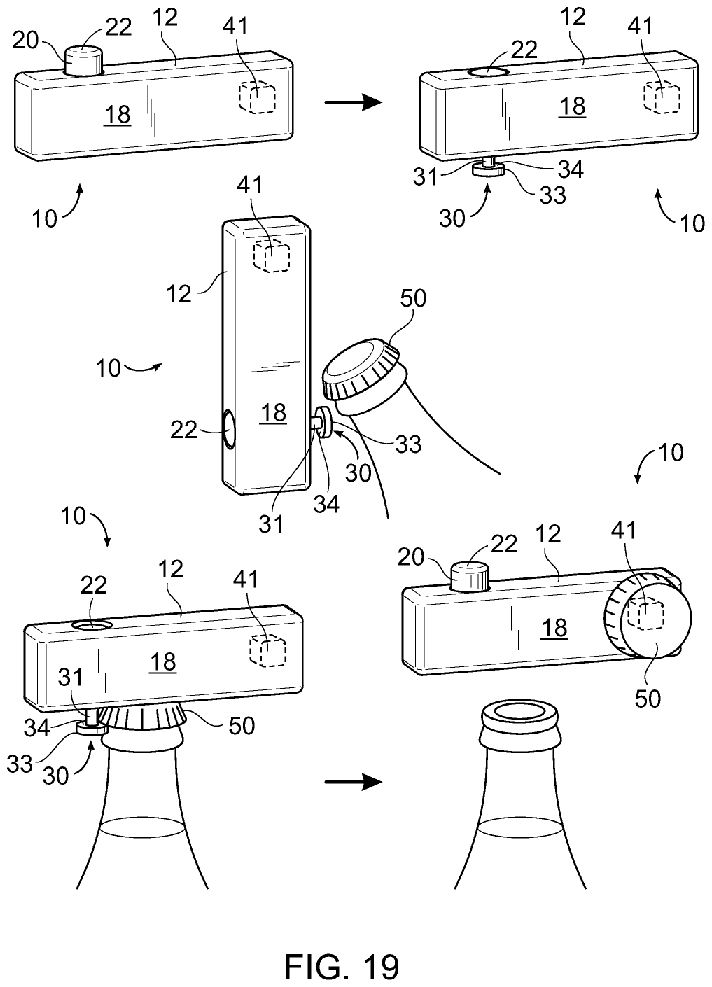

The carry attachment 14 can be a simple through hole to attach a lanyard or key ring. The carry attachment 14 can also be of the form shown in the second alternative embodiment of FIGS. 12-14. The body 12 may be used to mount a bolt that holds keys and a strong, flat loop that acts as a carry attachment 14. The body 12 can also have an embedded magnet 41 as shown in FIG. 19. This magnet 41 can allow the user to temporarily secure the bottle opener to any number of metal surfaces. The magnet 41 can also act to secure a bottle cap 50 and prevent it from falling once it is removed from a bottle.

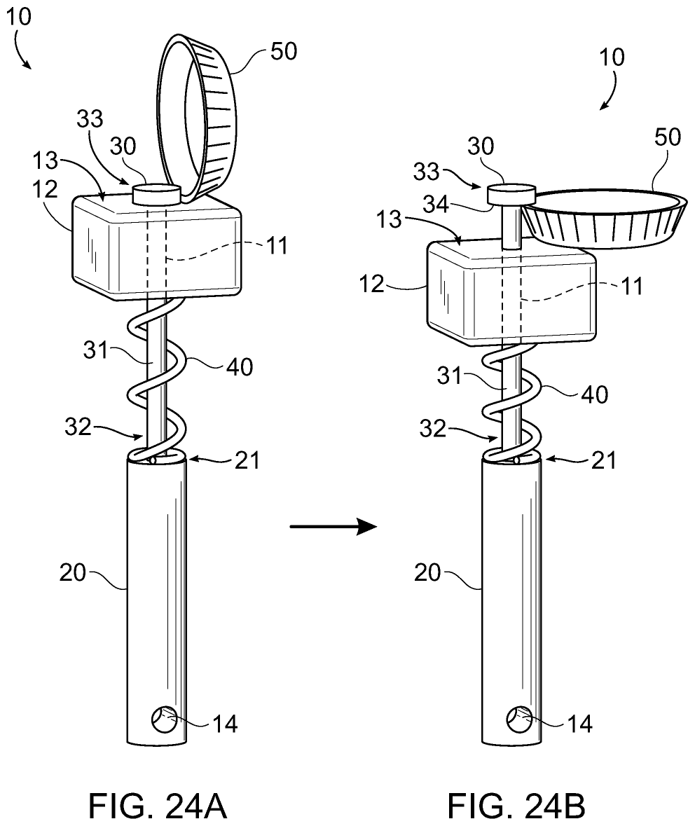

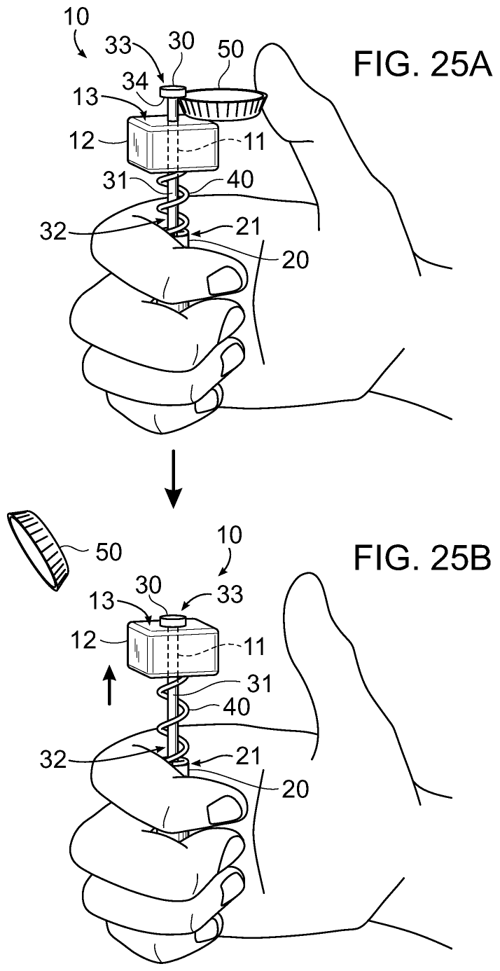

In an alternative embodiment, such as the launcher-only version shown in FIGS. 24A through 25B, the body may be smaller than in other embodiments, and used to provide a hole for the pry tooth 30, on which the body may freely slide. Further, compression spring 40 is positioned over the shaft 31 of pry tooth 30. In this configuration, the spring 40 is compressed between the body and the collar 20. This embodiment, as shown, is more compact than some of the other embodiments, and still has a carry attachment 14 so that it may easily be carried on a user's belt, key ring, etc.

C. Collar.

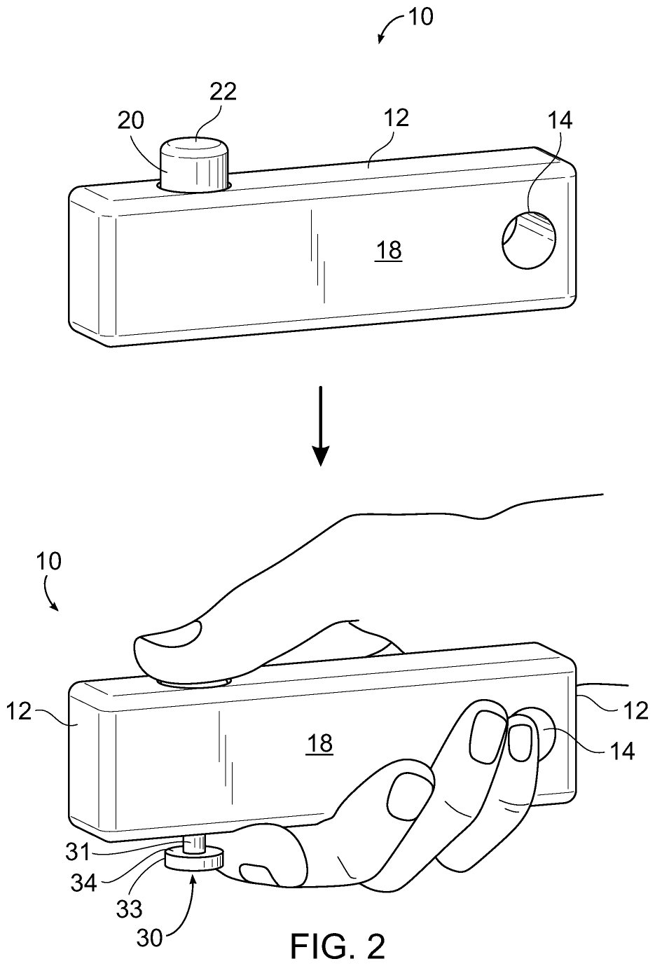

As mentioned above, the collar 20 prevents the pry tooth 30 from being pulled completely out of the body 12. The collar 20 also serves to retain the compression spring 40 on the shaft 31 of the pry tooth 30. The collar 20 can also help lessen lateral forces on the pry tooth 30 by limiting its play in the body 12. The collar 20 also serves in some example embodiments as a pushbutton to allow the pry tooth 30 to be extended, by a user pushing on face or pushbutton surface 22 of the collar, as shown for example in FIG. 2. The collar 20 may be removably or adjustably attached to the pry tooth 30 to aid in assembly, disassembly, or adjustment of the extent by which the pry tooth extends beyond the body 12 of the opener 10.

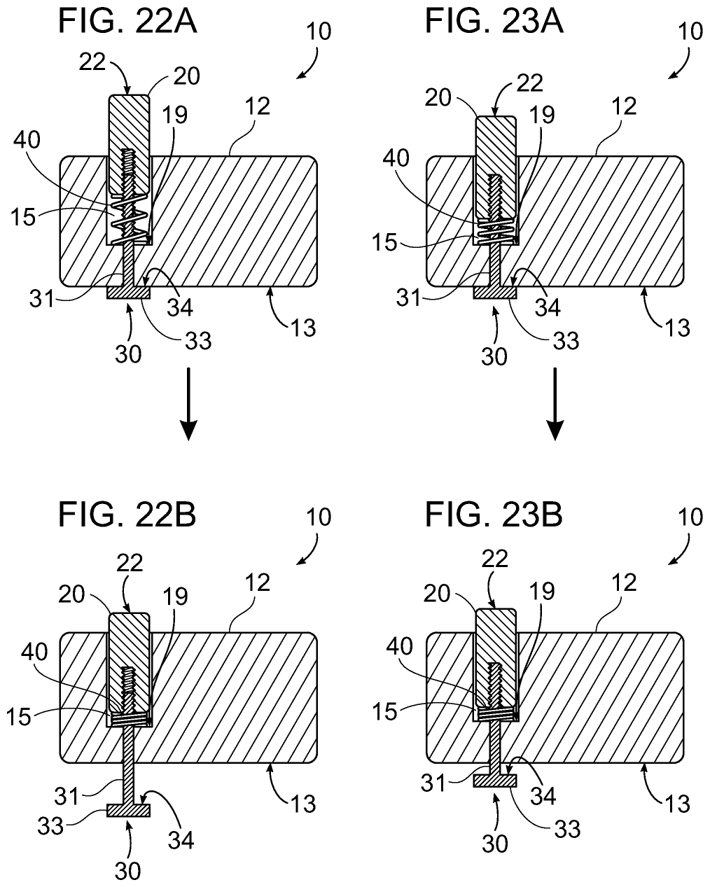

The collar 20 can be of any height in order to extend out from the body 12 far enough for a user to push on the push button surface 22 in any of the example embodiments. As shown in FIGS. 22A-B and 23A-B, the pry tooth can be adjustably installed in the collar, for example, by screwing it in to different depths, in order to adjust or change the degree to which the pry tooth extends beyond the body 12 when the pushbutton face 22 of collar 20 is pushed.

The dimensions of the collar 20 can vary widely depending on the design of the bottle opener without changing the underlying functions described above in the detailed description of the collar 20. The collar may be constructed of strong material to withstand the forces of prying off a bottle cap. The collar 20 may attach to the top of the pry tooth 30 to prevent the pry tooth 30 from being pulled out of the body 12 as the bottle opener is used. There may be a relatively strong connection between the collar 20 and pry tooth 30 to prevent inadvertent separation, but there should also be a way to combine the two with relative ease.

In one example embodiment, the collar 20 may simply be a locknut threaded onto the coupling end 32 of the pry tooth 30, as shown in FIG. 16. Other embodiments may use a collar 20 made from a female threaded rod known in the robotics and computer chip industries as a standoff.

Thread lock materials or devices may also be used in order to prevent the female threaded collar 20 from backing off the male threads of the coupling end 32 of the pry tooth 30. The collar sidewall 23 may contact the collar cavity 15 of the body 12 when the bottle opener is used. When a user is prying a bottle cap off a bottle there is considerable force pulling against the pry tooth 30 tending to pull the pry tooth 30 out of the body 12. In addition to this force, there is a smaller torque force on the pry tooth 30 that pulls the pry end 33 away from the bottle cap. To prevent this force from pulling the pry end 33 out from beneath the bottle cap, the collar sidewall 23 will transfer the force to the body 12 by pushing against the wall of the collar cavity 15. Simply put, the collar 20 sitting in a rather snug collar cavity 15 helps keep the pry tooth 30 aligned in the body 12 when the pry tooth 30 is being used to open bottles.

Conversely, if the collar 20 fits loosely in collar cavity 15, the pry tooth 30 may come out from beneath the bottle cap and not function properly. The degree to which the collar sidewall 23 pushes on the collar cavity 15 of the body 12 also depends on the size of the shaft opening 11 in the shelf 16 through which the shaft 31 of the pry tooth 30 passes. Other functions of the collar 20 are to secure the compression spring 40 on the shaft 31 of the pry tooth 30, and provide a push button face 22 for extension of the pry tooth 30. An alternative embodiment, as shown in FIGS. 9-11 show a functional variation with the absence of an exposed pushbutton face 22. In this embodiment, the collar 20 cannot be reached or seen, so the pry tooth is extended by hooking it with a bottle cap 50 and turning the opener as shown in FIG. 11.

In the alternative, launcher-only embodiment described above, the collar 20 is much longer, and is also external to the body 12, as best shown in FIGS. 24A and 24B. As shown in FIGS. 25A and 25B, in this embodiment the longer collar 20 acts as a handle, and is held in position by a user while the body 12 extends and retracts along pry tooth shaft 31 to launch bottle caps.

D. Pry Tooth.

The pry tooth 30 extends from the lower portion of the body 12 to engage a bottle cap 50 for removal. The pry tooth 30 is generally of a size and shape that allows an edge to be placed under the bottle cap. The pry tooth 30 is generally made of strong material, such as metal, to withstand the forces of prying. The pry tooth 30 in each embodiment may be round when viewed down its long axis, although of course other shapes are possible. The pry end 33 was 0.25 inches in diameter in all of the prototypes. The shaft 31 was 0.125 inches in diameter in all of the prototypes of the opener. The shaft 31 diameter being smaller than the pry end 33 diameter creates a lip onto which the bottle cap 50 is placed during removal. The pry tooth 30 extends from the body 12 roughly 5 millimeters in all of the prototypes. A crown bottle cap 50 is roughly 7 millimeters tall.

The pry end 33 may be positioned to slightly pull up the edge of a bottle cap by the time the leverage face 13 is flat across the top of the bottle cap. This tight fit of the bottle cap 50 in between the pry end 33 of the pry tooth 30 and the leverage face 13 helps assure proper leverage on the bottle cap 50 during removal. The pry end 33 may be roughly 1.5 millimeters thick from the outermost edge to the start of the shaft 31. This dimension is important because the pry end 33 must fit between the crown cap of the bottle and the outside wall of the bottle.

For example, if the pry end 33 were 3 millimeters from the edge to the shaft, it might not fit beneath the crown cap as in FIG. 3, and could hit the glass bottle and not be able to function. If the pry end 33 were much shorter it might not have the strength needed to pry off bottle caps without bending. The construction of the pry tooth 30 in one example embodiment may comprise a stainless steel shoulder bolt, with a 0.50 inch long shaft with a #4-40 threaded coupling end 32. The pry tooth 30 could have a multitude of shapes and sizes that would still function as shown herein, and in addition, different means may be used to couple the shaft to the collar 20. For example, the lip of the pry end 33 may be machined into a different shape than shown for improved grip beneath the bottle cap to prevent slippage. The pry end 33 may also be shaped into an angle in one example embodiment in order to function as a tapered box opener.

E. Compression Spring.

The compression spring 40 serves as a means of retracting the pry tooth 30 when not in use. When the pry tooth 30 is engaged under a bottle cap, the compression spring 40 may become fully compressed and help transfer forces from the body 12 of the bottle cap remover. The compression spring 40 is generally constructed of material to help transfer forces without getting damaged when fully compressed, yet compressible with one finger if necessary for extension of the pry tooth 30.

The choice of compression spring 40 must be carefully paired with the size of pry tooth 30 used and the design of the shelf 16 in the body 12. The compression spring 40 should be strong enough to allow full retraction of the pry tooth 30 into the pry tooth recess 17, yet also allow a user to extend the pry tooth 30 with relative ease with one finger pushing on the pushbutton face 22 of the collar 20. The compression spring 40 may have a number of parameters altered from the above description and still perform as designed and described herein. A flexible rubber sleeve or possibly two magnets with repelling poles could also be implemented to retract the pry tooth in the same fashion as the compression spring 40.

F. Fabrication of an Example Embodiment.

The body 12 may be made from a solid block of material. The collar cavity 15 may be drilled from one side, and the pry tooth recess 17 drilled on the other. The shaft opening 11 in the shelf 16 is then drilled to connect the cavity and the recess. The pry tooth shaft 31 has a coupling end 32 that is threaded and thread locker tape may be placed on these threads. The shaft 31 is passed up through the shelf 16 from the pry tooth recess 17, and compression spring 40 is placed on the shaft 31 as it sits in the collar cavity 15. The collar coupling end 21 is then threaded onto the pry tooth coupling end 32. The resulting, main components of the opener 10 are shown prior to assembly in FIG. 8.

In order to use the invention, a user pushes down on the push button face 22 of the collar 20 to extend the pry tooth 30 and compress the compression spring 40. The pry end 33 is then placed beneath the edge of a bottle cap and the leverage face 13 of the body 12 is placed on top of the bottle cap 50. The user then applies pressure to the bottle cap opener 10 in a fashion that pries the cap off the bottle, as shown in FIG. 3. The compression spring 40 returns to its extended state and retracts the pry tooth 30 into the body 12 upon release, as shown in FIG. 4.

G. Alternative Embodiments.

FIGS. 9-11 show a variation in which the user does not have to depress the collar 20 in order to extend the pry tooth 30. The pry tooth recess 17 in this embodiment allows the user to pull the pry tooth 30 out of the body 12 with the bottle cap 50. All of the main elements are present as in the preferred embodiment, but the collar 20, pry tooth 30, and compression spring 40 are all contained inside the body 12. FIG. 12 shows a variation on the way the body 12 is carried. All of the main elements are present just as in the preferred embodiment, but the carry attachment 14 is an external strip with a keyring hole, and a bolt is used to attach keys to the bottle opener 10. The purpose of making the pry tooth 30 retractable is to enhance portability and make it one of the things people may carry with them at all times along with their keys.

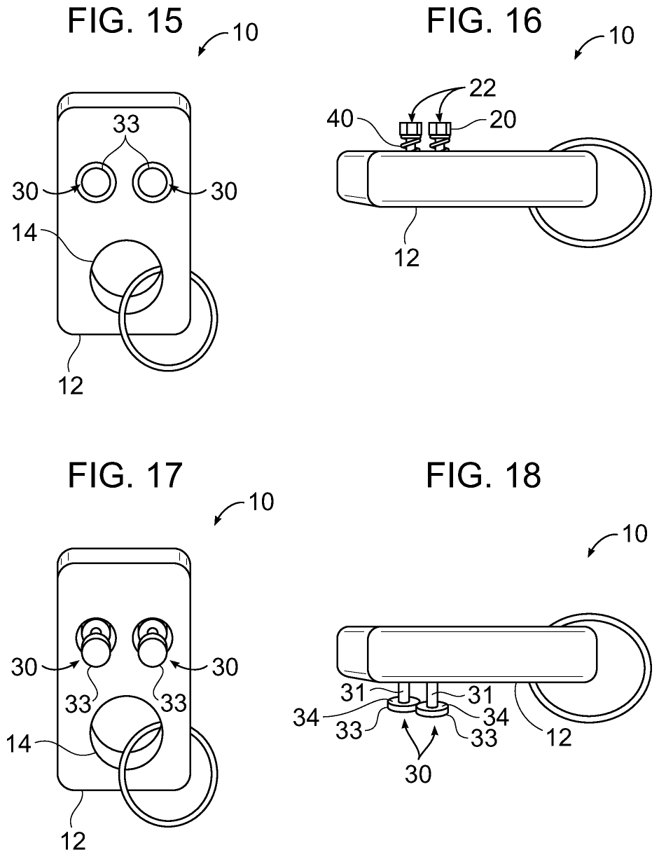

The combination of bottle opener and key holder is expected to help the marketability of the example embodiments. FIGS. 15-18 show an alternative embodiment that uses a multiple pry teeth 30. All of the main elements are present as in the preferred embodiment, but in this case there are two pry teeth 30. A user could potentially use both pry teeth 30 at the same time to pry off a bottle cap, but the difficulty is increased. A user would certainly be able to more easily control one pry tooth 30 and use it to open bottles as in the preferred embodiment. This embodiment is entertaining, as it is designed to resemble a funny face, with the pry teeth 30 appearing as eyes that may be made to pop out of the face when the collars 20 are pushed from the opposite side. The embodiment of FIG. 19 incorporates a magnet 41 as a carry attachment, and in addition, the magnet 41 can function to retain a bottle cap 50 after it has been pried from the bottle.

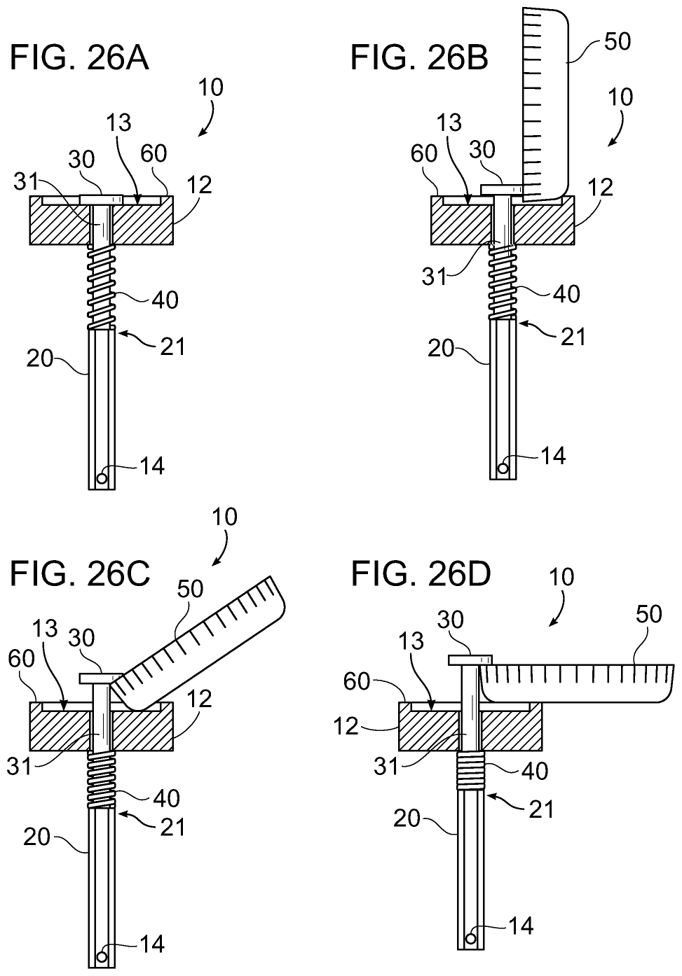

Also, as discussed above, an embodiment may be made and used that is more compact, and is just a launcher. In this embodiment, shown generally in FIGS. 24A through 28, the body 12 is smaller and has a shaft opening 11 that rides on the shaft 31 of the pry tooth 30, and is urged by the force of compression spring 40 away from the collar 20. The collar may still include a carry attachment 14, as shown in FIGS. 26A-26D, which allows for easy attachment to a keychain, etc. When the body is away from the collar as far as it will go, the body 12 and spring 40 are in their relaxed position. The coupling end 32 of the pry tooth 30 is attached securely to collar 20 at the collar coupling end 21 using any of the techniques described above with regard to coupling the pry tooth 30 to the body 12. In these embodiments, the body has a relaxed and a compressed position. In its relaxed position, shown in FIGS. 24A and 26A, the leverage face 13 of the body rests against, and is held in place by, the pry end inner surface 34. The compressed position (due to the compressed condition of spring 40) is shown in FIGS. 24B and 26D, wherein the body 12 is positioned closer to the collar 20, and compresses spring 40 to a greater degree than in the relaxed position.

In use, this embodiment is the same or similar to other embodiments when launching bottle caps 50, as the edge of the bottle cap 50 is leveraged between the pry tooth 30 and the body 12 and launched when a user holds and then releases the bottle cap 50.

The components of this alternative embodiment may be made of any of the materials discussed above, and may also have varied shapes and sizes. For example, the collar 20 may be cylindrical, substantially (e.g., mostly) cylindrical, or have a square, rectangular, hexagonal (as shown, for example, in FIGS. 26-28), or other cross-sectional shape, and may have surfaces suitable for placing advertising, logos, etc. as with the body in other embodiments. Similarly, the body 12 and pry tooth 30, and their parts or openings, may have different shapes. For example, the pry tooth shaft 31 may be round, or may be multi-sided across its length, and the corresponding features of the body 12 and collar 20 may be adjusted in order to accommodate different shapes.

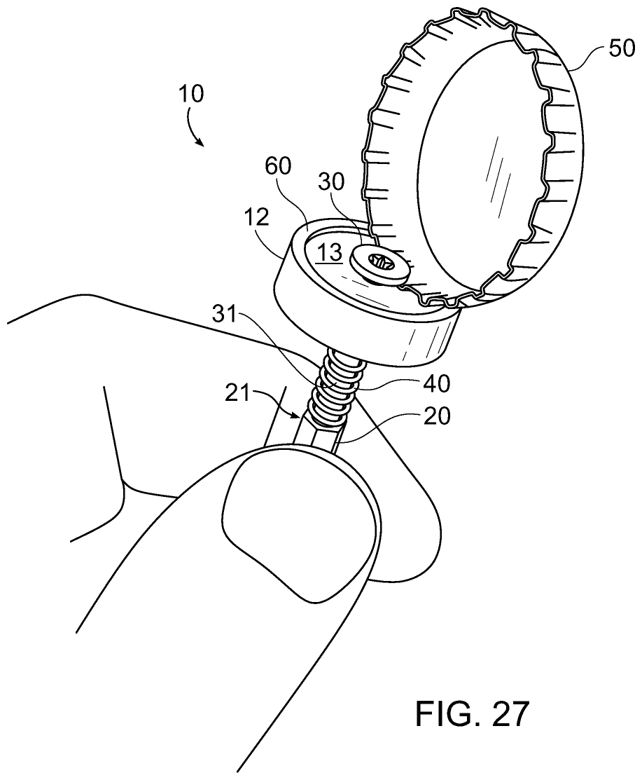

As shown in FIGS. 26A-26D, 27, and 28, the body 12 may have a circular upper flange 60 that extends somewhat higher than the upper surface 13 of the body 12. As best shown in FIGS. 26B and 27, this flange 60 is sized and shaped so that it holds and engages the edge of bottle cap 50, which allows the user to rest, switch hands, or reposition and re-grip the launcher, as desired, without the bottle cap 50 falling or springing out of the launcher 10. The flange 60 also helps force the cap 50 up against pry tooth 30 when the spring 40 is compressed. The spring 40 pushing up on the body 12 supports this, effectively holding the cap 50 in place until the user is ready to launch it.

Because the flange 60 hold the bottle cap 50 in place without input from a user, a user can also use another bottle cap or other object, rather than just a fingertip, to hold and launch the cap. As with the previous embodiment, the spring 40 is held in position by pry tooth shaft 31, and is compressed between the body 12 and the collar 20. The spring 40 may be sized so that it is partially compressed even at rest, as shown in FIG. 26A, while it is further compressed as shown in FIGS. 26B-26D and 27-28. Further, the relative sizes of the components shown in FIGS. 26-28, as well as the other figures, may be different while allowing the launcher or opener/launcher to work in the same manner. For example, the body 12 may be thicker, and the pry tooth shaft 31 and collar 20 may have a larger diameter, and the spring 40 may also be larger, if it is desired to make a launcher 10 that is more powerful, in other words, for use as a “driver” in a miniature golf game, rather than a smaller “iron”.

Another benefit of the flange 60 in this embodiment is that it makes shots more accurate, due to the flange 60 engaging the lower surface of the bottle cap 50 when the cap is released, preventing the cap from launching to the left or right of its intended path.

H. Operation of Preferred and Alternative Embodiments.

In general use, the user first extends the pry tooth 30 from the body 12 by depressing the push button face 22, which in turn compresses the compression spring 40 as seen in FIGS. 5 and 6. The pry end 33 of the pry tooth 30 is then exposed and available to place under a bottle cap as shown in FIG. 3.

In use, the pry tooth end 33 is secured beneath the edge of the bottle cap and pulled toward the user to lodge the pry end 33 beneath the edge of the bottle cap 50 while pressing the body 12 down so the leverage face 13 comes into contact with the top of the bottle cap 50. The user then pulls upwards on the end of the body 12 with the pry tooth 30 while pushing downwards on the other end of the body 12 as in FIGS. 3 and 4, and the bottle cap 50 will be pried off the bottle.

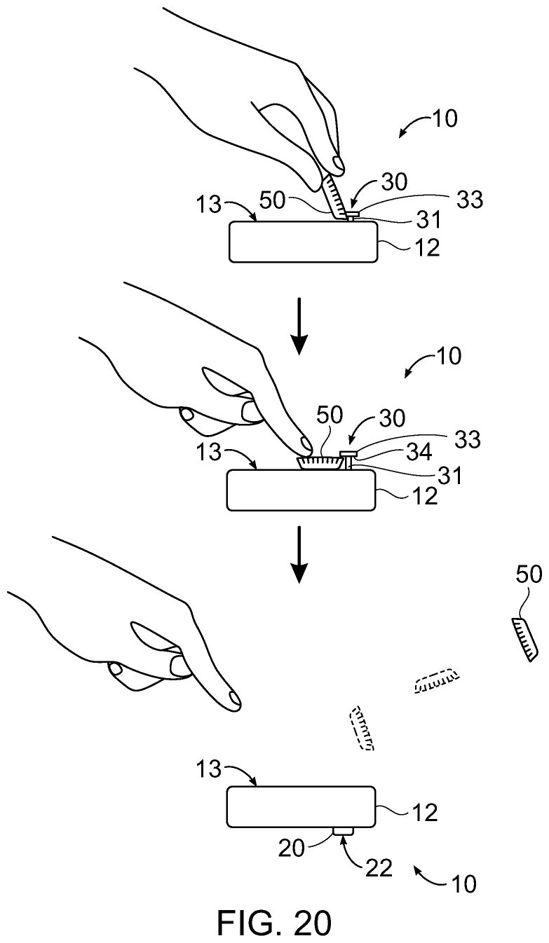

As a user becomes more familiar with the operation, the user can hold the freed bottle cap 50 with the ends of the fingers and maintain the location of the bottle cap 50 beneath the extended pry tooth 30 with the top of the bottle cap still against the leverage face 13 of the body 12. The user can then let go of the bottle cap 50 and the return of the compression spring 40 to its original position will quickly retract the pry tooth 30 while at the same time flinging the bottle cap 50 away from the user. Alternatively, a user may load a loose bottle cap 50 into the pry tooth by depressing the push button face 22 to extend the pry tooth 30 and using the loose bottle cap to pry the pry tooth 30 out to its fullest extent as in FIG. 20. In addition to opening bottles, the pry end 33 can also help open soda and beer cans that have today's common stay-tab design. A user may extend the pry end 33 and place it beneath the tab on the top of the can and pull the tab up enough to more easily get a finger beneath the tab.

With regard to launching bottle caps, the alternative embodiment of FIGS. 24A through 28 may also be used. In this more compact embodiment, the body 12 is smaller, and is external to the collar 20. In use, a user holds the collar 20 in one hand, as shown in FIGS. 25A and 25B. The edge of a bottle cap 50 is inserted under pry end 33 of pry tooth 30, and the edge on the other side of the cap is held down by the user's thumb as shown in FIG. 25A, or a finger or multiple fingers on the user's other hand. This action moves the body 12 toward collar 20 and compresses spring 40 between the body 12 and the collar 20, and all components are generally held in position by the user except the spring and the body.

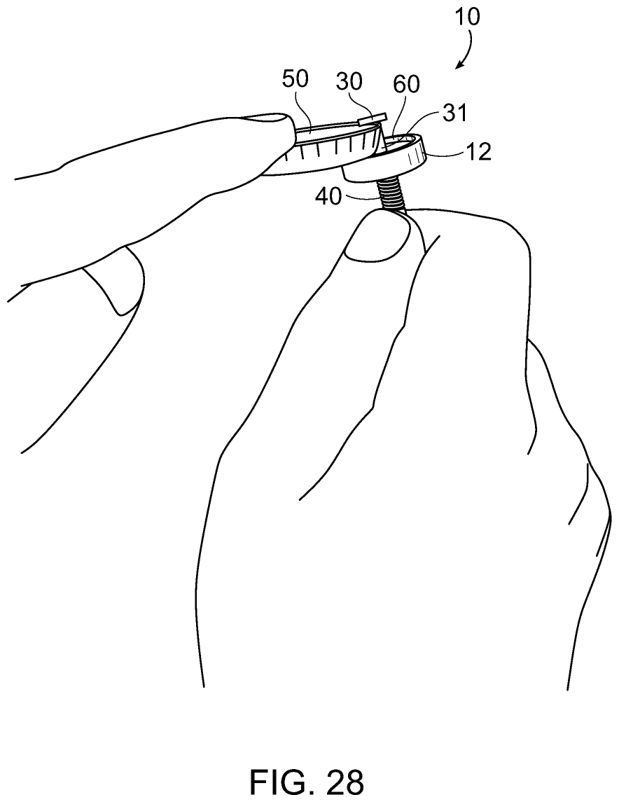

To launch a bottle cap 50, as shown in FIGS. 25B and 28, the user simply releases the edge of the bottle cap 50 with his thumb or finger, which allows spring 40 to quickly force the body 12 toward the pry end 33 of the pry tooth 30, as indicated by the arrow, and fling the bottle cap 50 away from the user as shown, and as also described above.

The user can thus launch, flip, or fling the bottle cap 50 at a particular target, bottle, or cup, while taking part in a game, such as an indoor version of miniature “golf,” using bottle caps and cups or other targets. If the body 12 starts to stick on the shaft 31 or becomes difficult to move into the compressed position, a drop of oil may be placed on the shaft 31 or in the opening 11 in the body so that smooth operation may resume.

Unless otherwise defined, all technical and scientific terms used herein have the same meaning as commonly understood by one of ordinary skill in the art to which this invention belongs. Although methods and materials similar to or equivalent to those described herein can be used in the practice or testing of the bottle cap opener and launcher, suitable methods and materials are described above. All publications, patent applications, patents, and other references mentioned herein are incorporated by reference in their entirety to the extent allowed by applicable law and regulations. The bottle cap opener and launcher may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A bottle cap launcher, comprising:
a pry tooth having a shaft, a pry end, and a second end;
a body having a first surface and a shaft opening, wherein the pry tooth shaft extends through the shaft opening and wherein the body is slidable on the pry tooth shaft;
a collar having a coupling end coupled to the pry tooth shaft at the second end; and
a compression spring positioned between the collar and the body, such that the compression spring urges the body toward the pry end;
wherein the body is movable between a relaxed position and an compressed position on the pry tooth shaft.

2. The bottle cap launcher of claim 1, wherein the body comprises a flange extending beyond the first surface.

3. The bottle cap launcher of claim 2, wherein the shaft opening has a circular cross section.

4. The bottle cap launcher of claim 1, wherein the shaft opening has a circular cross section.

5. The bottle cap launcher of claim 1, wherein an inner surface of the pry end contacts the first surface when the pry tooth is in the relaxed position.

6. The bottle cap launcher of claim 5, wherein the pry tooth shaft is cylindrical.

7. The bottle cap launcher of claim 6, wherein the shaft opening has a circular cross section.

8. The bottle cap launcher of claim 5, wherein the shaft opening has a circular cross section.

9. The bottle cap launcher of claim 1, wherein the collar is substantially cylindrical.

10. The bottle cap launcher of claim 9, wherein the pry tooth shaft is cylindrical and coaxial with the collar.

11. The bottle cap launcher of claim 1, wherein the collar has a hexagonal cross section.

12. A method of using the bottle cap launcher of claim 1, comprising:
engaging an edge of a bottle cap between the pry tooth and the body;
using the bottle cap as a lever to move the body into the compressed position on the pry tooth shaft;
holding the bottle cap against the body such that a portion of the bottle cap holds the body in the compressed position; and
releasing the bottle cap such that the compression spring moves the body to the relaxed position and launches the bottle cap.

13. A bottle cap launcher, comprising:
a pry tooth having a shaft, a pry end, and a second end;
a body having a first surface and a shaft opening, wherein the pry tooth shaft extends through the shaft opening and wherein the body is slidable on the pry tooth shaft;
a collar having a coupling end coupled to the pry tooth shaft at the second end; and
means for moving the body between a relaxed position and a compressed position relative to the collar.

14. The bottle cap launcher of claim 13, further comprising a flange extending beyond the first surface.

15. The bottle cap launcher of claim 14, wherein the shaft opening has a circular cross section.

16. The bottle cap launcher of claim 13, wherein the shaft opening has a circular cross section.

17. The bottle cap launcher of claim 13, wherein an inner surface of the pry end contacts the first surface when the pry tooth is in the relaxed position.

18. The bottle cap launcher of claim 17, wherein the pry tooth shaft is cylindrical.

19. The bottle cap launcher of claim 18, wherein the shaft opening has a circular cross section.

20. The bottle cap launcher of claim 17, wherein the shaft opening has a circular cross section.
